(19) United States
(12) Patent Application Publication
(10) Pub. No.: US 2005/0008629 A1
(43) Pub. Date: Jan. 13, 2005

(54) Encapsulated AGF cells

(75) Inventor: Douglas M. Arm, Mission Viejo, CA (US)

Correspondence Address: QUINE INTELLECTUAL PROPERTY LAW GROUP, P.C., P O BOX 458, ALAMEDA, CA, 94501, US

(73) Assignee: Interpore Orthopaedics, a Delaware Corporation

(21) Appl. No.: 10/434,442

(22) Filed: May 7, 2003

Related U.S. Application Data
(60) Provisional application No. 60/379,116, filed on May 8, 2002.

(51) Int. Cl. A01N 1/02

(52) U.S. Cl. 424/93.71; 435/2

(57) ABSTRACT

This invention provides a composition of encapsulated blood constituents. The invention provides methods to make and use the encapsulated blood constituents, e.g., to stimulate and support tissue regeneration with autologous growth factors.

### CROSS-REFERENCE TO RELATED APPLICATIONS

This application claims priority to and benefit of a prior U.S. Provisional Application No. 60/379,116, “Encapsulated AGF Cells”, by Douglas M. Arm, filed May 8, 2002. The full disclosure of the prior application is incorporated herein by reference.

### FIELD OF THE INVENTION

This invention is in the field of encapsulated blood constituents. The present invention relates to, e.g., encapsulated blood constituents and methods of their use. The encapsulated constituents can, e.g., include one or more peripheral blood cell and/or blood protein. The cells and/or proteins can, e.g., release one or more growth factor and/or cytokine through pores in the capsule wall. The cells and/or proteins can, e.g., be released through pores or by dissolution of the capsule. The encapsulated blood constituents can be used, e.g., to promote tissue regeneration or to provide one or more autologous growth factors (AGF) and/or cytokines to a patient.

### BACKGROUND OF THE INVENTION

Whole blood is made up of many constituents, including red blood cells, white blood cells, platelets and plasma. Many of these constituents can release growth factors and cytokines, which can trigger immune responses, cell growth or other biological phenomena.

Growth factors are generally peptide signal molecules released into the interstitial media by a cell to bind at a specific receptor on another cell. The binding of growth factors with their receptors can initiate a signal cascade to activate mechanisms of cell growth, division, differentiation, etc.

Cytokines are generally peptide signal molecules that bind to receptors on cell membranes to activate cell migration. Cytokines can also provide a chemical gradient that can attract mobile cells to accumulate at a particular location. Current use of the term cytokine is quite broad to indicate substantially any intercellular signal peptide. Cytokines are important mediators of immune, inflammatory and healing responses.

Cytokines can be released to when cells or tissues are injured. Some peptide fragments of activated coagulation proteins act as cytokines to attract or hold immune system cells to the site of the injury. Aggregated platelets at the site can release cytokines along with growth factors. As immune system cells accumulate at the injury site, they interact in a kind of positive feedback to release a variety of their own cytokines and growth factors. The site of the injury can become crowded with a complex assortment of blood cells and migratory cells from other tissues exchanging signals and attracting additional cells. The attracted cells can perform a variety of duties such as attacking foreign bodies, cleaning up cell debris and sealing vessel walls. After the initial inflammatory response to the injury, the cell growth and tissue repair mechanisms begin to predominate. Endothelial cells are stimulated to grow, divide and repair vessel walls. Fibroblasts can be stimulated to migrate into the site and lay down connective tissue fibers. A matrix structure can be formed onto which blasts and other pleuropotential cells can differentiate to regenerate injured tissues.

From the discussion above, it is apparent that blood constituents, such as blood proteins, platelets and white cells play a major role in initiation of tissue repair processes.

White blood cells (WBCs) include a diverse array of cell types, e.g., lymphocytes, macrophages, polymorphonuclear neutrophils (PMNs), eosinophils, mast cells, dendritic cells, and more. WBCs are generally somewhat less dense than RBCs and, together with platelets, can form a white “buffy coat” layer on top of RBCs during centrifugation of whole blood. WBCs in a buffy coat can release a variety of growth factors and cytokines.

Platelets are cell fragments shed into the blood stream by large megakaryocyte cells in the bone marrow. Platelets play an important role in coagulation of blood and sealing of injured vessels. When platelets contact damaged blood vessels, they can aggregate and send chemical messages that can initiate the coagulation cascade and attract various cells. In addition, platelets can release growth factors, including platelet derived growth factor (PDGF), which can stimulate the growth of endothelial cells.

Red blood cells (RBCs) are flexible biconcave cells packed with hemoglobin which carry oxygen throughout the body. RBCs are not known to release growth factors. However, RBCs can be damaged by immune responses through the complement cascade or cause severe immune responses if infused into an ABO incompatible patient.

Plasma is a complex aqueous solution of proteins, lipids, small molecules and salts which acts as the transport medium for other blood constituents. Plasma also contains elements, e.g., coagulation proteins, compliment cascade proteins, hormones, buffers, nutrients, etc., necessary for the function of various biological systems. Plasma may contain growth factors and cytokines released by cells in contact with the blood stream. In addition, activated elements of plasma proteins can act as cell adhesion molecules, cytokines and growth factors.

The interaction of blood and tissue at an injury site can provide a foundation for tissue regeneration. Some tissues, such as liver, show a strong potential for regeneration. However, other tissues fail to regenerate well and the healing process leads only to fibrosis and scarification.

Surgical or therapeutic intervention can sometimes aid in tissue regeneration. For example, a gap in a bone fracture can sometimes be bridged with an artificial bone matrix and recombinant growth factors. However, appropriate progenitor cells do not always migrate into the new bone matrix. Recombinant growth factors can be provided to stimulate growth and differentiation of cells but they may not localize well at the fracture site.

The repair and immune systems of many patients is too compromised by age or illness to mount adequate clean up and repair at the injury site. These patients can use a way to boost their weak response to injuries.

Biotechnology has successfully cloned recombinant copies of most the known growth factors and cytokines such as IGF, PDGF, FGF, IL-2, etc. Such factors might stimulate migration, repair and growth responses at an injury site, as mentioned above. Yet, injury repair has been difficult to promote with recombinant factors because of the difficulty of local application, the variety of factors involved in tissue repair and the intricacies of repair signal timing.

In view of the above, a need exists for ways to locally apply a complex variety of growth factors, cytokines and/or cells to damaged tissues in a patient. It would be desirable to have minimally antigenic or autologous provision of such factors in a patient speed repair and regrowth of damaged tissues. The present invention provides these and other features that will be apparent upon review of the following.

### SUMMARY OF THE INVENTION

The present invention includes, e.g., blood constituents in a porous capsule to provide beneficial healing factors. The blood constituents can include a variety of blood proteins and living cells capable of releasing a variety of cytokines and growth factors in situ. The invention provides methods of making and using encapsulated blood constituents to promote regeneration of tissues. The invention also includes methods for storing encapsulated blood constituents.

The encapsulated blood constituents of the invention can, e.g., include one or more separated and/or concentrated blood constituents encapsulated in a water or gas permeable matrix. The matrix can be, e.g., in the form of a membranous capsule or a three dimensional open pore matrix made up of a polymeric material such as alginate, cross-linked blood proteins, gelatin, polyvinyl alcohol, ethylcellulose, styrene maleic anhydride, a self-assembled monolayer, cellulose acetatephthalate, and/or the like.

The matrix material can be, e.g., made from materials that substantially fail to initiate aggregation of platelets and/or clot formation in plasma. The matrix material can be, e.g., made from biodegradable materials. The pore size of the matrix material can, e.g., have a molecular weight cut off of not more than about 500 kDa, not more than about 100 kDa, or not more than about 3 kDa.

The encapsulated blood constituents can include, e.g., blood plasma proteins, platelets, white blood cells, buffy-coat, and/or the like. The buffy-coat can provide, e.g., 10⁶ or more platelets per ml, 1.5×10⁴ or more WBCs per ml, and/or 5 mg/ml or more of fibrinogen. The encapsulated blood constituents can include ostioblasts, chondrocytes, progenitor cells, and/or blasts. The encapsulated blood constituents of the invention can include, e.g., blood cells which release one or more growth factors and/or cytokines. The growth factors can include, e.g., epidermal growth factor (EGF), insulin like growth factor (IGF), platelet derived growth factor (PDGF), transforming growth factor (TGF), vascular endothelial growth factor (VEGF), fibroblast frowth factor (FGF), and/or the like. The cytokines can include, e.g., interleukins, interferons, CSF, compliment fragments, coagulation cascade fragments, and/or the like. The encapsulated blood constituents can be provided with supplemental constituents, such as bioactive agents, nutrients, stability enhancing agents, anticoagulant, and/or drugs.

The present invention provides a method of regenerating tissue. In the method, blood constituents are separated and/or concentrated before encapsulation in a matrix. The encapsulated blood constituents can be embedded at a site requiring tissue regeneration where they can promote regeneration of the local tissue. The blood constituents can be separated and/or concentrated using automated instrumentation. The blood constituents can include, e.g., plasma proteins, platelets, white blood cells, buffy-coat, and/or the like. The buffy-coat can include, e.g., 10⁶ or more platelets per ml, 1.5×10⁴ or more WBCs per ml, and/or 5 mg/ml or more of fibrinogen. The blood constituents can be autologous to the tissue at the site of regeneration.

The tissue regeneration methods of the invention provide blood constituents with additional osteoblasts, chondrocytes, progenitor cells, and/or blasts. The method provides encapsulated blood constituents with supplemental constituents including bioactive agents, nutrients, stability enhancing agents, anticoagulants, and/or a drugs.

The matrix used in the tissue regeneration methods can form, e.g., a membrane structure or three dimensional open pore matrix of alginate, cross-linked blood proteins, gelatin, polyvinyl alcohol, ethylcellulose, styrene maleic anhydride, a self-assembled surface active layers, and/or cellulose acetatephthalate. Encapsulating can comprises, e.g., forming a continuous layer of polymeric material about aqueous droplets of the blood constituents.

The method can provide autologous blood proteins to tissues at the site of tissue regeneration. The encapsulated blood constituents can release growth factors and/or cytokines at the tissue regeneration site to, e.g., promote healing and/or recruit migratory cells. The growth factors can include, e.g., EGF, IGF, PDGF, TGF, VEGF, FGF, and/or the like. The cytokines can include, e.g., interleukins, interferons, CSF, compliment fragments, and/or coagulation cascade fragments.

The methods of tissue regeneration can include blending the encapsulated blood constituents with a bone growth matrix and/or a cartilage growth matrix before embedding the encapsulated blood constituents at a site of tissue regeneration. The growth matrix can include, e.g., porous ceramic, coralline hydroxyapatite, collagen, mineralized collagen, hyaluronic acid and derivatives, calcium carbonate, tri-calcium phosphate, an open pore biocompatible foam, hydroxyapatite ceramic, magnesium sulfate, polyester, autogenous bone, allograft bone, allograft cartilage, and/or the like.

The methods of the invention can provide autologous blood constituents, cytokines and/or growth factors to a patient. The method can, e.g., include the steps of separating and/or concentrating blood constituents of the patient, encapsulating the blood constituents in a matrix, and transfusing the encapsulated blood constituents into the patient, thereby providing the patient with autologous constituents and/or factors. The factors can include, e.g., EGF, IGF, PDGF, TGF, VEGF, FGF, interleukins, interferons, CSF, compliment fragments, and/or coagulation cascade fragments. The patient in the method of the invention can be a mammal. The encapsulated blood constituents can be provided with supplemental constituents such as bioactive agents, nutrients, stability enhancing agents, anticoagulants, and/or drugs. Additional cells, such as ostioblasts, chondrocytes, progenitor cells, and/or blasts, can be included with the blood constituents.

An automated instrument can be used to prepare the blood constituents, such as plasma proteins, platelets, white blood cells, and/or buffy-coat, for patients in the methods of the invention. The buffy-coat can comprise, e.g., 10⁶ or more platelets per ml, 1.5×10⁴ or more WBCs per ml, and/or 5 mg/ml or more of fibrinogen.

The matrix used in the method of providing autologous blood constituents in the invention can include, e.g., materials such as alginate, cross-linked blood proteins, gelatin, polyvinyl alcohol, ethylcellulose, styrene maleic anhydride, self-assembled surface active layers, and cellulose acetatephthalate, and the like. The blood proteins can be the patient's own. Encapsulating of the blood constituents in the method can include forming a continuous layer of polymeric material about aqueous droplets of the blood constituents. The method can additionally provide for storing the encapsulated blood constituents.

The method of providing blood constituents, growth factors and cytokines to patients in the invention can include, e.g., transfusing by injecting the encapsulated blood constituents into a peripheral blood vessel or a body compartment of the patient. The matrix can be dissociated upon transfusion of the encapsulated blood constituents into the patient. Dissociation can be, e.g., driven by enzymes, ionic effects, heat and/or osmotic pressure. Factors released from a patients stored blood constituents can be provided to the patient.

### BRIEF DESCRIPTION OF THE DRAWINGS

FIG. 1 is a block flow diagram of an exemplary method of tissue regeneration in a patient.

FIG. 2 is a schematic diagram of a composition to stimulate regeneration of bone tissue.

### DETAILED DESCRIPTION

The present invention provides, e.g., encapsulated blood constituents for in situ production of autologous growth factors and cytokines. Blood constituents can, e.g., be separated and concentrated before encapsulation in a membranous or matrix capsule. The encapsulated blood constituents can then, e.g., be embedded at a site of tissue regeneration or placed in storage for later use in the source or compatible patient.

In practice, blood constituents from a patient can be, e.g., separated and concentrated by centrifugation and filtration to provide desired pure or mixed compositions of blood constituents. The constituents can be, e.g., blended with supplemental constituents, such as undifferentiated tissue forming cells, and encapsulated in porous biocompatible membranes. A paste of concentrated capsules can be, e.g., blended with a scaffolding of collagen and surgically applied into the site of a connective tissue injury in the patient. Autologous growth factors from the patient's own blood constituents can then, e.g., stimulate vascularization of the scaffolding and differentiation of cells to regenerate tissue at the site.

Separation and Concentration of Blood Constituents

Many blood constituents can be separated according to their density. When whole blood is subjected to centripetal force or gravity, blood constituents consecutively settle in the order RBCs, WBCs, platelets, and plasma. A mixture of WBCs and platelets that settles on top of RBCs is called a buffy-coat.

Plasma can be separated from whole blood by a long or fast centrifugation that settles all the cellular constituents. To ensure that the plasma does not clot, anticoagulants such as heparin, EDTA, or Wares citrate can be added to the blood. The plasma supernatant can be harvested by decanting or aspiration. Plasma proteins can be concentrated by ultrafiltration with a membrane having pores with an appropriate molecular weight cut off, e.g., 3 kDa to about 500 kDa, or about 200 kDa, as is commonly practiced in the art.

Platelets can be separated from whole blood by a brief centrifugation that settles most of the RBCs and WBCs but leaves most of the platelets in a supernatant of platelet rich plasma (PRP). The PRP can be removed by aspiration into another centrifuge bottle for a longer and/or harder centrifugation to pellet the platelets. A platelet concentrate remains when the plasma supernatant is decanted or aspirated. Alternately, the PRP can be concentrated using a microfiltration or ultrafiltration membrane. The platelet count of normal whole blood is about 150,000 to 400,000 per microliter. In a platelet or buffy coat concentrate, platelets can be concentrated to, e.g., about 1×10⁶ per microliter or more.

WBCs can be separated from whole blood, e.g., by a brief centrifugation that settles most of the WBCs on top of a bed of RBCs leaving most of the platelets in a PRP. The PRP can be removed by aspiration or by decanting. The WBCs can be removed from on top of the RBCs by aspiration or by scraping. Residual platelets and/or RBCs in the WBCs thus harvested can be removed by additional centrifugations in platelet free plasma or in certain non-toxic viscous or buoyant solutions known in the art. Normal WBC counts in peripheral blood are, e.g., 4,000 to 11,000 cells per microliter. WBCs in a concentrate of buffy coat can number, e.g., about 20,000 per microliter or more.

Buffy-coat, a mixture of WBCs, platelets and plasma, can be harvested by centrifugation of whole blood, removal of the plasma supernatant and aspiration or scraping the buffy coat cells. Buffy coat can be beneficially encapsulated in the present invention to release a rich array of cytokines and growth factors. Alternately, individually separated blood constituents and/or concentrates can be recombined in any proportions to provide release of a desired the type and quantity of growth factors and cytokines.

Automated systems to separate blood components are well known, e.g., in the blood banking industry. For example, blood components can be separated by centrifugation of whole blood (see, e.g., U.S. Pat. No. 3,145,713, “Method and Apparatus for Processing Blood” and U.S. Pat. No. 4,151,844, “Method and Apparatus for Separating Whole Blood into Its Components and for Automatically Collecting One Component”). In a copending application Ser. No. 10/422,369, “Blood Separation and Concentration System”, by Douglas M. Arm, et al., filed Apr. 23, 2003, an automated system of sensors, pumps and valves can separate blood constituents in a centrifuge and concentrate selected constituents by ultrafiltration to provide concentrated blood constituents suitable for encapsulation and treatment of patients.

Encapsulation of Blood Constutuents

Blood constituents of the invention can be encapsulated, e.g., in membranous polymer capsules or in a three dimensional open pore polymer matrix. The polymers can be, e.g., biodegradable and/or non-degradable.

Living cells can be encapsulated in biocompatible permeable membranous capsules by various methods know in the art. For example, the cells can be suspended in a medium, such as sodium alginate, that can be reversibly gelled by adjustment of the ionic environment. The cells suspended in alginate can be extruded as droplets into a calcium chloride solution where the alginate hardens to envelop the droplets in temporary capsules. A permanent capsule can be formed, e.g., by coating and cross-linking a cationic molecule such as polylysine, or other polyamino acid, over the negatively charged temporary alginate capsule. Finally, the alginate can be dissolved and removed by suspending the encapsulated cells in a media, such as PBS or citrate buffer, that removes calcium from the alginate. What remains are cells encapsulated in a cross-linked biocompatible porous membrane.

Various additional porous layers can be deposited over the capsule described above. For example, polyvinyl alcohol, polylactic acid, polybeta-hydroxy butyric acid and polyglycolic-lactic acid copolymers can be used to form biocompatible outer coatings on the capsules.

Blood constituents can be encapsulated in a three-dimensional open-pored matrix media by various methods known in the art. For example, blood constituents in aqueous media can be encapsulated in calcium alginate in a fashion similar to producing the temporary capsules described above.

Blood constituents of the invention can be encapsulated in biodegradable media such as collagen, hyaluronic acid, hydrolyzable polyester, polyorthoester, degradable polycarbonate, polyanhydride, degradable polycarboxylate, polycaprolactone, and copolymers, block copolymers, and blends of these polymers, and/or the like. Biodegradable polymers are particularly useful where encapsulated blood constituents are embedded at a location where they can not be later removed or where tissue regeneration is intended to displace the embedded capsules.

Blood constituents of the invention can be encapsulated in non-biodegradable media such as polytetrafluoroethylene, perfluorinated polymers, silicone elastomer, polyurethane, polyethylene, polypropylene, polyethylene teraphthalate, polysulfone, non-degradable polycarboxylate, non-degradable polycarbonate, non-degradable polyester, poly(hydroxymethacrylate), polymethylmethacrylate, polyamides, copolymers, block copolymers, and blends of these polymers, and/or the like. Non-biodegradable polymers are particularly useful where the encapsulated blood constituents are embedded at a location where they can be removed or where the capsules are intended to remain as a supporting structure for the regenerated tissue.

Additional Constituents

Additional constituents can be included within a capsule of blood constituents or in the environment around the capsules to enhance growth and differentiation potentialities. Additional constituents can include, e.g., undifferentiated cells, fillers and/or time-release bioactive agents.

Undifferentiated cells (e.g., blasts, pluripotential cells and immature cell types), committed cells, and fully differentiated cells can be included, along with encapsulated blood constituents, in some embodiments of the invention. For example, chondrocytes or osteoblasts can be present inside biodegradable capsules with the blood constituents to be released at a bone fracture to build new bone after the initial inflammatory response. The undifferentiated cells can be included outside of non-biodegradable capsules, e.g., to build new tissues in the environment of cells and connective tissue fibers promoted by the capsules of blood constituents.

Growth factors, cytokines and other bioactive agents, e.g., which are not produced adequately by the encapsulated blood constituents for regeneration of a particular tissue type can be provided in a composition. Agents, such as platelet derived growth factor (PDGF), insulin-like growth factor-1 (IGF-1), IGF-2, basic fibroblast growth factor (bFGF), acidic FGF, vascular endothelial cell growth factor (VEGF), endothelial growth factor (EGF), insulin, interleukin 1 (Il-1), Il-2, tumor necrosis factor, connective tissue growth factor (CTGF), transforming growth factor (TGF), para-thyroid hormone (PTH), prostaglandins such as prostaglandin E-1 and prostaglandin E-2, angiogenesis factors, macrophage colony stimulating factor (MCSF), and corticosteroids such as dexamethasone, prednisolone, and corticosterone, can be included inside the capsule and/or in the media around the capsules. Bioactive agents can be incorporated into a biodegradable capsule matrix for time release as the matrix decomposes. The agents can be incorporated into a non-biodegradable matrix for time release by gradual diffusion from the matrix.

One or more filler substrate can be provided with the encapsulated blood constituents to supply a scaffolding for growth of new tissue. A filler substrate such as coralline hydroxyapatite, collagen, mineralized collagen, hyaluronic acid and derivatives, calcium carbonate, tri-calcium phosphate, an open pore biocompatible foam, hydroxyapatite ceramic, magnesium sulfate, polyester, autogenous bone, allograft bone, and/or allograft cartilage, can be mixed with capsules of the invention before application to a site of tissue injury.

Use of Encapsualted Blood Constituents

Encapsulated blood constituents can be applied to the site of tissue damage to stimulate and/or support tissue regeneration. The capsules of the invention can be injected, e.g., into a body cavity, a blood vessel, and/or at the site of an injury. The capsules can be surgically applied, e.g., to fill a void in a damaged tissue.

Encapsulated blood constituents can be held in storage until use. Storage buffer can include, e.g., cell culture media and other components suitable for injection into a patient. Oxygen and nutrients can pass through the porous polymer capsule to sustain the living cells. Capsules can be held at lowered temperatures, e.g., less than about 4° C. to about 15° C., to slow degradation and to minimize the metabolic requirements of the cells. Storage media can be rinsed away and replaced with specialized injection media before administration of capsules to a patient.

Blood constituents encapsulated in individual membranous capsules can be, e.g., injected into the site requiring tissue regeneration using a needle and syringe. Most organs are surrounded with a peripheral membranous connective tissue which can localize the injected capsules. Capsules can be injected into various body cavities, e.g., the pleural cavity, thoracic cavity, and/or pericardium, as appropriate, to stimulate tissue repair in the region defined by the cavity.

Encapsulated blood constituents can, e.g., be applied in the form of a paste or gel to fill a site for tissue regeneration. A concentrate of encapsulated blood constituents can have the consistency of a paste for application in a tissue void. Bioactive agents released from the capsules can induce migration of connective tissue cells and tissue specific progenitor cells to regenerate functional tissue in the void. The paste can also include fillers, as described above, to provide structural support and a surface for new cell growth. A rigid or semi-rigid shell can be provided to enclose the paste in a restricted compartment in which new tissue new tissue can obtain a desired size and shape.

A tissue void can be filled with blood constituents encapsulated in a three dimensional open pore matrix. The matrix can be shaped to, e.g., precisely fit into the void. The matrix can additionally include tissue progenitor cells and/or supplemental bioactive agents to promote regeneration of the specific desired tissue type.

### EXAMPLE

The following example is offered to illustrate, but not to limit the claimed invention.

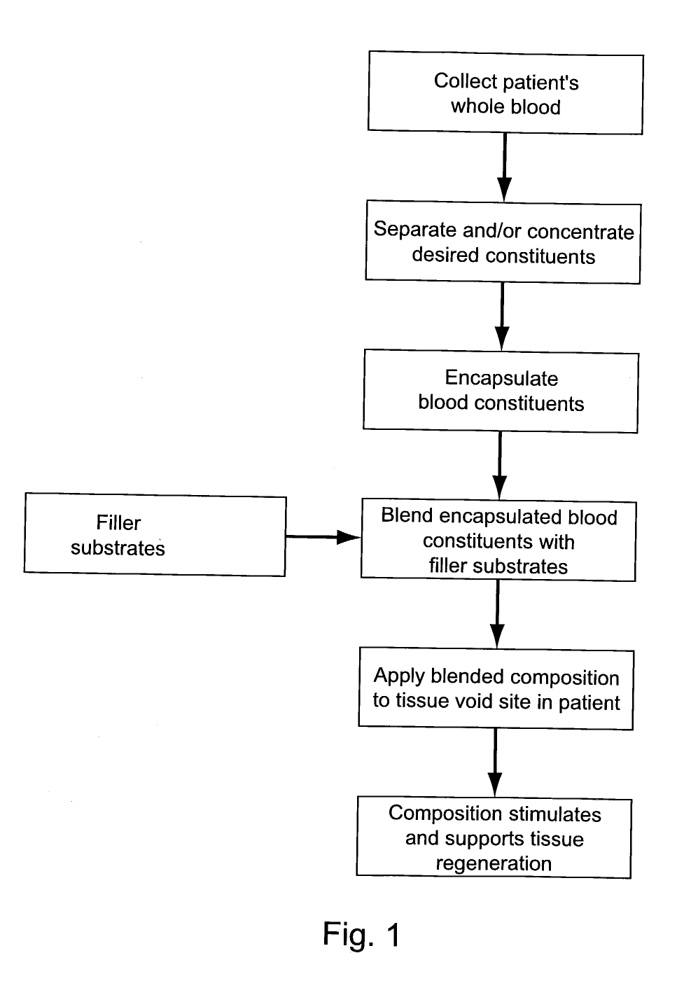

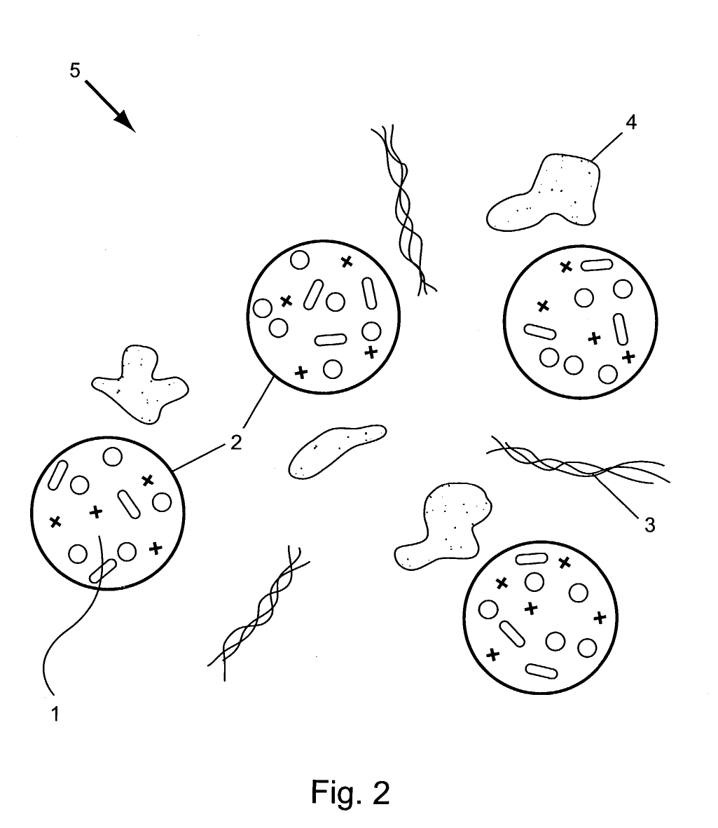

After a bacterial infection in bone (osteomyelitis), a void can remain at the site that does not heal to fill with bone tissue. A composition is prepared and embedded in the void to stimulate regeneration of normal healthy bone tissue at the site (see, method diagram FIG. 1). The composition includes the patient's own buffy-coat cells encapsulated in polylysine capsules and blended with filler substrates (see, FIG. 2).

Buffy-coat concentrate 1, containing WBCs, platelets, and plasma, is prepared from the patients blood. A unit (440 ml) of whole blood is collected into Ware's citrate anticoagulant and centrifuged at 1000×g for 10 minutes. Using sterile procedures, buffy-coat cells are aspirated off the top of the red cell bed using a pipette attached to a collection trap connected to a vacuum source. The buffy-coat, along with associated plasma, is concentrated by 100 kDa ultrafiltration in a Centriprep® style centrifuge driven concentrator.

Buffy coat concentrate 1 is encapsulated by suspension in sodium alginate, extrusion as droplets into a calcium chloride solution to form temporary calcium alginate capsules, self assembly in a polylysine solution of a positively charged polylysine coat over the negatively charged temporary alginate capsules, and dissolving the temporary alginate capsule with a solution of sodium citrate, thereby leaving buffy-coat cells encapsulated in polylysine capsule 2.

Encapsulated buffy-coat cells 1 are combined with filler substrates to form a bone regeneration composition. Collagen substrate 3 and coralline hydroxyapatite 4, known in the art and suitable for surgical application in humans, are mixed with the patient's encapsulated buffy-coat concentrate to form bone regeneration composition 5.

An incision is made through the patient's skin and any remaining periostium to expose the void in the bone tissue. Unviable tissue is abrided so healthy tissue defines the void. The surgeon applies the bone regeneration composition with a spatula to fill the void. The composition is covered by suturing periostium (or connective tissue membrane surgical devices known in the art) over the site. The incision is closed.

The patient's healing mechanisms interact with the bone regeneration composition to regenerate healthy bone in the void. The buffy-coat cells release autologous growth factors and other bioactive agents through the capsule to recruit tissue cells and to stimulate growth. Ostioblasts and fibroblasts migrate into the composition from healthy bone surrounding the void and establish bone forming zones on the scaffolding provided by the collagen and hydroxyapatite fillers. The biodegradable polylysine capsules and their contents are eventually absorbed. Over time, a matrix of normal healthy bone replaces the composition and the void is filled.

It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference in their entirety for all purposes.

1. Encapsulated blood constituents comprising:
a matrix comprising water permeable pores; and,
one or more blood constituents encapsulated by the matrix;
wherein the blood constituents are separated or concentrated blood constituents.

2. The encapsulated blood constituents of claim 1, wherein the matrix forms a membrane structure.

3. The encapsulated blood constituents of claim 2, wherein the matrix comprises material selected from the group consisting of: an alginate, a self assembled monolayer, cross-linked blood proteins, gelatin, polyvinyl alcohol, ethylcellulose, styrene maleic anhydride, self-assembled surface active layers, and cellulose acetatephthalate.

4. The encapsulated blood constituents of claim 1, wherein the matrix comprises a three dimensional open pore matrix.

5. The encapsulated blood constituents of claim 4, wherein the open pore matrix comprises material selected from the group consisting of: an alginate, cross-linked blood proteins, gelatin, polyvinyl alcohol, ethylcellulose, styrene maleic anhydride, self-assembled surface active layers, and cellulose acetatephthalate.

6. The encapsulated blood constituents of claim 1, wherein the matrix comprises one or more materials that substantially fail to initiate aggregation of platelets or clot formation in plasma.

7. The encapsulated blood constituents of claim 1, wherein the matrix comprises one or more biodegradable materials.

8. The encapsulated blood constituents of claim 1, wherein the pores have a molecular weight cut off of not more than about 500 kDa.

9. The encapsulated blood constituents of claim 8, wherein the pores have a molecular weight cut off of not more than about 100 kDa.

10. The encapsulated blood constituents of claim 9, wherein the pores have a molecular weight cut off of not more than about 3 kDa.

11. The encapsulated blood constituents of claim 1, wherein the blood constituents comprise one or more blood plasma proteins.

12. The encapsulated blood constituents of claim 1, wherein the blood constituents comprise platelets.

13. The encapsulated blood constituents of claim 1, wherein the blood constituents comprise white blood cells.

14. The encapsulated blood constituents of claim 1, wherein the blood constituents comprise buffy-coat.

15. The encapsulated blood constituents of claim 14, wherein the buffy-coat comprises 10⁶ or more platelets per ml, 1.5× or more WBCs per ml, or 5 mg/ml or more of fibrinogen.

16. The encapsulated blood constituents of claim 1, wherein the blood constituents comprise blood cells which release one or more growth factors or cytokines.

17. The encapsulated blood constituents of claim 16, wherein the growth factors are selected from the group consisting of: EGF, IGF, PDGF, TGF, VEGF and FGF.

18. The encapsulated blood constituents of claim 16, wherein the cytokines are selected from the group consisting of an interleukin, an interferon, a CSF, a compliment fragment, and a coagulation cascade fragment.

19. The encapsulated blood constituents of claim 1, further comprising supplemental constituents selected from the group consisting of: a bioactive agent, a nutrient, a stability enhancing agent, an anticoagulant, and a drug.

20. A method of regenerating tissue, the method comprising:
separating or concentrating one or more blood constituents;
encapsulating the blood constituents in a matrix; and,
embedding the encapsulated blood constituents at a tissue regeneration site;
thereby promoting regeneration of tissue at the site.

21. The method of claim 20, wherein the separating or concentrating of the blood constituents comprises processing whole blood or blood components with an automated instrument.

22. The method of claim 20, wherein the blood constituents comprise one or more blood plasma proteins.

23. The method of claim 20, wherein the blood constituents comprise platelets.

24. The method of claim 20, wherein the blood constituents comprise white blood cells.

25. The method of claim 20, wherein the blood constituents comprise buffy-coat.

26. The method of claim 25, wherein the buffy-coat comprises 10⁶ or more platelets per ml, 1.5×10⁴ or more WBCs per ml, or 5 mg/ml or more of fibrinogen.

27. The method of claim 20, wherein the blood constituents and the tissue at the site of regeneration are autologous.

28. The method of claim 20, wherein the encapsulated blood constituents further comprise supplemental constituents selected from the group consisting of: a bioactive agent, a nutrient, a stability enhancing agent, an anticoagulant, and a drug.

29. The method of claim 20, wherein the matrix forms a membrane structure.

30. The method of claim 20, wherein the matrix comprises material selected from the group consisting of alginate, cross-linked blood proteins, gelatin, polyvinyl alcohol, ethylcellulose, styrene maleic anhydride, self-assembled surface active layers, and cellulose acetatephthalate.

31. The method of claim 20, wherein the blood constituents and the tissue at the site of tissue regeneration are autologous.

32. The method of claim 20, wherein encapsulating the blood constituents comprises forming a continuous layer of polymeric material about aqueous droplets of the blood constituents.

33. The method of claim 20, further comprising releasing growth factors or cytokines from the encapsulated blood constituents at the tissue regeneration site.

34. The method of claim 33, wherein the growth factors are selected from the group consisting of: EGF, IGF, PDGF, TGF, VEGF, and FGF.

35. The method of claim 33, wherein the cytokines are selected from the group consisting of: an interleukin, an interferon, a CSF, a compliment fragment, and a coagulation cascade fragment.

36. The method of claim 20, further comprising blending the encapsulated blood constituents with a bone growth matrix or a cartilage growth matrix before embedding the encapsulated blood constituents at the site of tissue regeneration.

37. The method of claim 36, wherein the growth matrix is selected from the group consisting of: porous ceramic, coralline hydroxyapatite, collagen, mineralized collagen, hyaluronic acid and derivatives, calcium carbonate, tri-calcium phosphate, an open pore biocompatible foam, hydroxyapatite ceramic, magnesium sulfate, polyester, autogenous bone, allograft bone, and allograft cartilage.

38. A method of providing autologous blood constituents, cytokines, or growth factors to a patient, the method comprising:
separating or concentrating blood constituents from the patient;
encapsulating the blood constituents in a matrix; and,
transfusing the encapsulated blood constituents into the patient,
thereby providing the patient with autologous constituents or factors.

39. The method of claim 38, wherein the growth factors are selected from the group consisting of: EGF, IGF, PDGF, TGF, VEGF, and FGF.

40. The method of claim, wherein the cytokines are selected from the group consisting of an interleukin, an interferon, a CSF, a compliment fragment, and a coagulation cascade fragment.

41. The method of claim 38, wherein the patient is a mammal.

42. The method of claim 38, wherein the separating or concentrating of the blood constituents comprises processing whole blood or blood components with an automated instrument.

43. The method of claim 38, wherein the blood constituents comprise one or more blood plasma proteins.

44. The method of claim 38, wherein the blood constituents comprise platelets.

45. The method of claim 38, wherein the blood constituents comprise white blood cells.

46. The method of claim 38, wherein the blood constituents comprise buffy-coat.

47. The method of claim 46, wherein the buffy-coat comprises 10⁶ or more platelets per ml, 1.5×10⁴ or more WBCs per ml, or 5 mg/ml or more of fibrinogen.

48. The method of claim 38, wherein the encapsulated blood constituents further comprise supplemental constituents selected from the group consisting of: a bioactive agent, a nutrient, a stability enhancing agent, an anticoagulant, and a drug.

49. The method of claim 38, wherein the matrix comprises material selected from the group consisting of alginate, cross-linked blood proteins, gelatin, polyvinyl alcohol, ethylcellulose, styrene maleic anhydride, self-assembled surface active layers, and cellulose acetatephthalate.

50. The method of claim 49, wherein the blood proteins are from the patient.

51. The method of claim 38, wherein encapsulating the blood constituents comprises forming a continuous layer of polymeric material about aqueous droplets of the blood constituents.

52. The method of claim 38, further comprising storing the encapsulated blood constituents.

53. The method of claim 38, wherein transfusing comprises injecting the encapsulated blood constituents into a peripheral blood vessel or a body compartment of the patient.

54. The method of claim 38, further comprising dissociating the matrix after transfusing the encapsulated blood constituents into the patient.
